(19) United States
(12) Patent Application Publication
(10) Pub. No.: US 2018/0053261 A1
(43) Pub. Date: Feb. 22, 2018

(54) Automated Compatibility Matching Based on Music Preferences of Individuals

(71) Applicant: Jeffrey Lee Hershey, State College, PA (US)

(72) Inventor: Jeffrey Lee Hershey, State College, PA (US)

(21) Appl. No.: 15/679,035

(22) Filed: Aug. 16, 2017

Related U.S. Application Data
(60) Provisional application No. 62/375,870, filed on Aug. 16, 2016.

(51) Int. Cl. G06Q 50/00; G06F 17/30

(52) U.S. Cl. CPC G06Q 50/01; G06F 17/30752

(57) ABSTRACT

A system and method for gathering music preference and listening habit data from existing data sources to create personal music profiles for the purpose of comparing profiles and using music preference data as a proxy for compatibility between individuals. This compatibility matching can be leveraged for dating and people matching applications, either via websites or mobile applications.

CROSS-REFERENCE TO RELATED APPLICATIONS

This application claims the benefit of U.S. Provisional Application No. 60/123,456, filed Aug. 16, 2016.

### FEDERALLY SPONSORED RESEARCH

Not Applicable

### SEQUENCE LISTING OR PROGRAM

Not Applicable

### BACKGROUND

Through the centuries, music has had many uses. Music has been used to entertain, inspire and even pass along key information and historical accounts. Perhaps above all, music has always had the power to bring people together. Music is the backdrop for daily life. Music highlights our celebrations, motivates our exercise, soundtracks our advertising and channels our emotions as we mourn. It also is the focal point of many key moments in peoples' lives. Music can evoke the full range of emotions. People often remark, “Oh, this song makes me think of that time when . . . ” Couples have an “our song” that they might eventually choose to dance to at their wedding. Music can be associated with public events, conflicts or even whole generations.

In many ways, music is the glue the binds people together. This is especially true with respect to relationships. Often, one of the first questions new acquaintances ask one another is, “What sort of music do you listen to?” Key moments in life are marked by music. Songs have long been used to court or set the mood for romantic situations. In recent decades, music has been used more and more frequently as a symbol of who one is and as a representation of how one is feeling. In the relationship context, this is epitomized by the creation of a “mix tape” for someone you care about or want to get to know better. The mix tape effectively serves an extension of one's self, one's personality, and is a means of sharing a bit of yourself through music.

Why are we so connected to our music? Because people want to connect with each other and they want to relate to one another. The foundation for these connections is shared interest and enjoyment in various aspects of life, including music.

Connecting in today's world can be difficult. People are working more and free time is at a premium. In a data-rich environment, many attempts have been made to streamline the process of connecting with new friends and potential partners. Recent dating or matchmaking services, for example, rely heavily on user provided data to generate potential matches. This process is often time consuming and tedious and can demand a level of self-understanding that many individuals lack. Simply put, it is too much work for many people.

What is needed is a more streamlined option to provide people compatibility matching services based on other data sources that represent one's personality and characteristics. An option that requires little input from the user and leverages their everyday behaviors to provide the basis for comparison and compatibility matching.

### BRIEF SUMMARY

A system and method for gathering Music Preference Data of individuals, analyzing that data to find probable matches among individuals based on Music Preference Data and enabling a range of applications including dating and people matching services, utilizing at least a processor for performing the steps of gathering Music Preference Data, performing compatibility analyses and powering matching applications.

An embodiment can leverage Music Preference Data to create a Personal Music Profile and/or a more condensed “music fingerprint” that is unique to an individual and can provide the basis for finding matches among groups of individuals, which can be enabled through a range of technologies, including websites and mobile device applications. Once potential matches are found, individuals can choose how they want to proceed, such as sharing more info, communicating or meeting, via a multitude of methods. Once connections have been made, a range of activities can be facilitated between individuals—including sharing ideas and suggestions about music, purchasing music, gifting music, curating playlists of music, arranging connections, purchasing event tickets, other merchandise, etc. These activities can be related to and support numerous business models.

### BRIEF DESCRIPTION OF DRAWINGS

FIG. 1. is a summary of the process of converting Music Preference Data into a Personal Music Profile.

FIG. 2. illustrates exemplary Music Preference Data sources and further detail of

Personal Music Profile and Personal Music Profile database creation.

FIG. 3. shows the Personal Music Profile Matcher, which interacts with the database of Personal Music Profiles to generate best matches per profile and clusters of similar profiles.

FIG. 4. illustrates the process by which a user-initiated search can generate best profile matches for that particular user with optional filtering by location and other criteria.

FIG. 5. illustrates an embodiment whereby multiple users utilizing mobile applications can perform rapid on-demand compatibility checks.

### DETAILED DESCRIPTION

In the following description, numerous specifics and details are set forth. However, it is understood that embodiments of the invention may be practiced without these specific details. In other instances, well-known techniques have not been shown in detail in order not to obscure the understanding of this description. Those of ordinary skill in the art, with the included descriptions, will be able to implement appropriate functionality without undue experimentation.

Because it is such a fundamental part of our lives, the music we listen to can reveal a lot about who we are. That music can, in fact, come to reflect key aspects of our personalities and can have deep connections to our emotions and overall preferences as people.

The present invention is a system and method for predicting compatibility between individuals and matching individuals using a plurality of methods and technologies for gathering Music Preference Data 100, a plurality of methods and technologies for analyzing Music Preference Data 100, a plurality of methods and technologies for identifying potential compatibility, and optionally integrating data from a plurality of other sources (e.g. user submitted data or location data).

### Overview

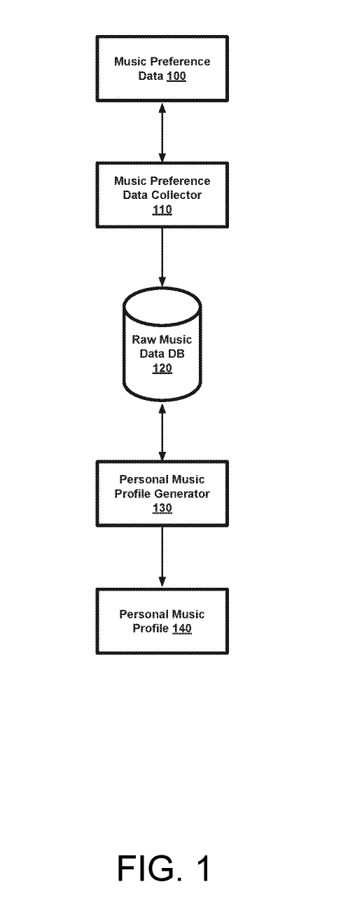

FIG. 1 illustrates the basic steps involved in collecting and analyzing Music Preference Data 100 to create a representation of those preferences in the form of a Personal Music Profile 140.

The Personal Music Profile 140 is a key basis for compatibility assessment and people matching. An individual's Personal Music Profile 140 is based on information from one or more sources, including an individual's music library on a local device(s) 101, cloud-based remotely hosted libraries such as an iTunes, Google Play Music, Amazon or other such service-based libraries 102 as well as an individual's music streaming data from services such as Pandora, Spotify, Soundcloud, etc. 103.

An individual's Personal Music Profile 140 can be created by utilizing existing music library and listening habit information pulled from one or more sources. This information can contain specifics such as artist, album, song title, genre, play frequency and other time-based factors as well as other characteristics of the music itself—such as fundamental elements of a song like tempo, beats per minute, rhythm components, lyrics and keywords, instruments used, musical keys, time signatures, etc. The information can be processed by a variety of methods to generate a unique music preference profile and an abbreviated, more compact “music fingerprint” for each user. The Personal Music Profile 140 and Personal Music Fingerprint 141 can serve as the cornerstones for compatibility analysis via a plurality of methods.

Each Personal Music Profile 140 can be comprised of a set of music-related characteristics collected into logical groups, other personal preferences and attributes such as location data, as well as, when appropriate and available, feedback and ratings given by and about individuals one to another. Once created, these Personal Music Profiles 140 can be stored in a Personal Music Profile DB 150, which can be accessed and analyzed for the purpose of compatibility evaluation and matching functions.

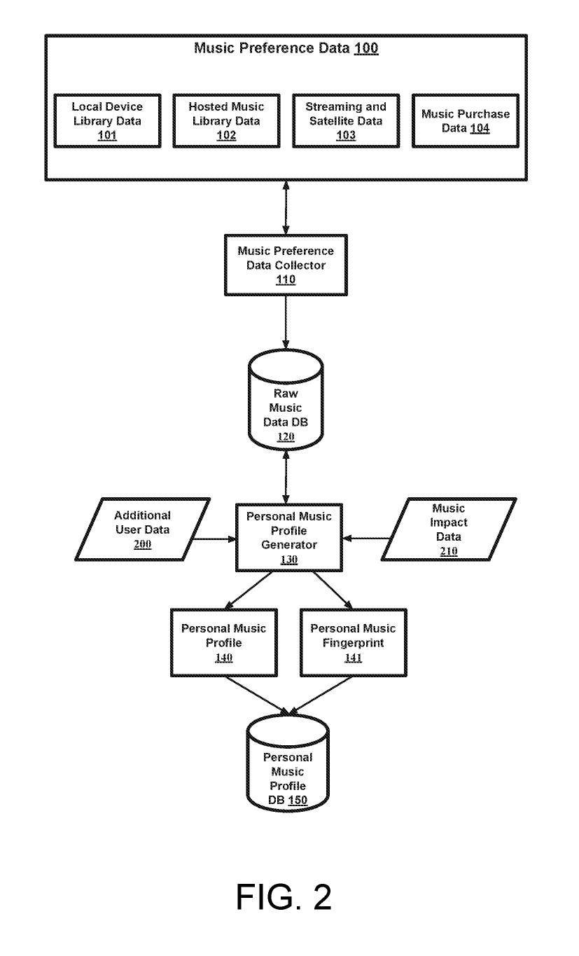

FIG. 2 details exemplary sources of Music Preference Data 100, which can be collected by a Music Preference Data Collector 110 and can be used to create a Raw Music Data DB 120. A Personal Music Profile Generator 130 then can analyze data from the Raw Music Data DB 120 along with Additional User Data 200 and Music Impact Data 210 to output a detailed Personal Music Profile 140 and summarized Personal Music Fingerprint 141.

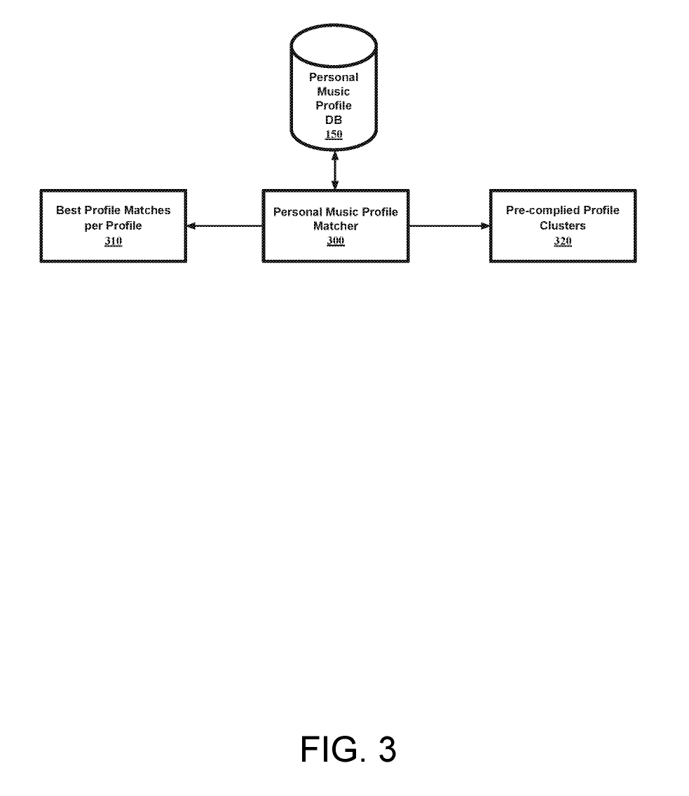

FIG. 3 illustrates the Personal Music Profile Matcher, which can apply heuristics to assess the distance between the Personal Music Profiles 140 in the Personal Music Profile DB 150 to generate Best Profile Matches per Profile 310 and groups of similar profiles or Pre-compiled Profile Clusters 320.

The matching functionality can be user initiated or automated, passive or dynamic, depending on the embodiment. Matches can be given strength ratings or classified by types of match based on various criteria linked to different aspects and characteristics of the profiles in question.

### Key Elements and Steps

### Personal Music Profile Creation

The Personal Music Profile 140 can be created using some or all of the following steps:

1. Music Data Collection via Music Preference Data Collector 110
a. Automated collection of user music information can be enabled by an application which gathers music metadata and other data by utilizing various APIs, file searching and parsing or other means. This music data can include but is not limited to existing library contents, listening history, search history, streaming history, playlists, application data and other personal information from a range of existing sources or datasets including but not limited to:
   iTunes Library or Playlist information from user computer or mobile device
   Google Play, Amazon or other cloud-based service libraries
   Android Media Scanner on user computer or mobile device
   Local storage scan of user computer or mobile device
   User listening or preference data Streaming sources (e.g. Pandora, Spotify, Google Play Music Stations)
   Satellite radio listening data
   Music purchase data from sources such as Amazon, iTunes, Google.
b. Manual entry of music data or cleaning or augmentation of automatically collected/scraped music data

2. Incorporation of Additional User Data 200
a. User data such as personally identifying information, contact information, geo-location information, and demographic information can be incorporated.
3. Incorporation of Music Impact Data 210
   a. Supplemental data provided by user via MIA (music impact assessment), which enables users to create associations between music and particular emotions elicited by particular music (songs, artists, genres, etc.) can be incorporated.

4. Data Curation and Analysis
a. Can include identifying and organizing key attributes within the raw music data, including but not limited to
   Artist
   Album
   Title
   Genre/Style
   Year
   Length
   Listening frequency
   Up or down voting or “favoriting”
   Personal ranking
   Timing aspects—such when listened to, how long been in library.
   Musical elements such as duration, tempo, pitch, timbre, structure, texture, rhythm, etc.
b. Incorporating and blending additional user and music impact data.
c. Analyzing the data and comparing to other profiles in the database using machine learning algorithms, pattern recognition and other statistical techniques.
d. Applying classification, association learning and clustering algorithms.
e. Applying rules engine to roll up complexity into standardized format/representation.
f. Applying learning models to reflect individuals' feedback about profiles and matches generated over time to refine and train the classification algorithms.
g. Applying filters, weighting and other adjustments based on individuals' input when applicable.
h. Outputting individuals' detailed Personal Music Profile 140, which can be stored as record in the Personal Music Profile DB 150.

### Personal Music Fingerprint

The Personal Music Fingerprint 141 is an approach to representing the Personal Music Profile 140 data in a more manageable, easily searchable and comparable unit. It can be generated through offline processing whereby all individuals in database are provided with a Personal Music Fingerprint 141, which can later be used common currency for matching purposes. One purpose of the Personal Music Fingerprint 141 can be to facilitate faster on-demand matching applications.

The Personal Music Fingerprint:

1. Can be derived fromf pre-processing of Personal Music Profile 140 information.

2. Can utilize a set of key characteristics to capture the complexity of user music preferences.

3. Can enable easier, faster classification and comparison of users—in particular when resources are less such as on a mobile device.

### Compatibility Matching

Compatibility matching using the Personal Music Profile Matcher 300 leverages data in Personal Music Profiles 140 and can be implemented using some or all of the following steps:

1. Applying recommendation engines, similarity matching, neural networks and other appropriate algorithms to find best matches between Personal Music Profiles 140 based on the multitude of data points include in the Personal Music Profiles 140.

2. Analyzing the Personal Music Profile 140 data and comparing to other Personal Music Profiles 140 in the database using machine learning algorithms, pattern recognition and other statistical techniques (e.g. Apriori, collaborative filtering, feature-based recommendation).

3. Applying filters, weighting and other adjustments based on individuals' input when applicable.

4. Outputting best matches for a particular Personal Music Profile 140 with strength ratings and filtering by other relevant attributes such as geo-based (physical distance), demographics and other personal information contained in the Personal Music Profiles 140.

5. Precompiling compatibility between subsets or all individuals in the Personal Music Profile DB 150 in addition to on-demand or user initiated matching requests.

6. Utilizing the complete Personal Music Profile 140 or summarized Personal Music Fingerprint 141 to support applications where advanced processing is not available and time is a key factor.

7. Applying learning models to incorporate and reflect individuals' feedback about Personal Music Profiles 140 and matches generated over time (via voting or other feedback collection system) to refine and train the matching process.

### APPLICATIONS

### Dating or People Matching

Predicting compatibility via Personal Music Profile 140 matching can be utilized for the purpose of a dating or people matching service whereby potentially compatible individuals may engage in activities or variety of relationships. A user can be presented with suggested matches of other users based on a compatibility score derived through analysis of the Personal Music Profile DB 150. The user then has options to get more information or connect with possible matches.

FIG. 3 illustrates the process whereby the Personal Music Profile DB 150 can be automatically and proactively analyzed to generate a set of Best Profile Matches per Profile 310 in order to provide users with a ranked list of possible compatible users based on Personal Music Profile 140 compatibility. Users can also search the Personal Music Profile DB 150 or view groups of like Personal Music Profiles 140 in the form of Pre-compiled Profile Clusters 320 generated by the Personal Profile Matcher 300.

Qualitative information about the match and the strength of the match can also be provided in addition to a “score” or summary of the match strength. Other filters also can be applied based on additional personal, location or other data.

Music preference based compatibility can be utilized for an interactive dating service. This service can include offline processing whereby all individuals in database are provided with a Personal Music Fingerprint 141, which can later be used for matching purposes and generation of a ranked compatibility list.

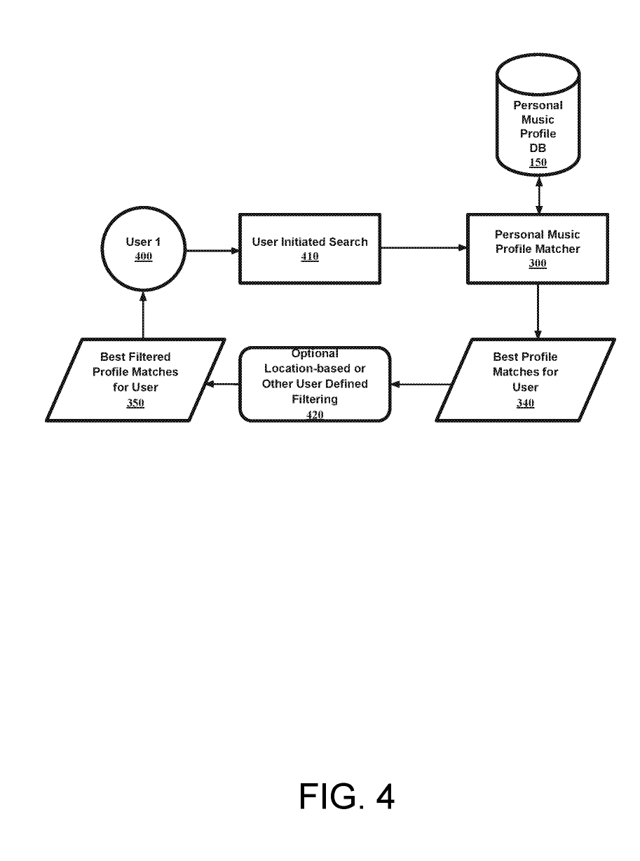

FIG. 4 shows an exemplary embodiment whereby a User 1 400 initiates a search of the Personal Music Profile DB 150 via the Personal Profile Matcher 300, which generates Best Profile Matches for User 340 for User 1 400. Optional Location-based or Other User Defined Filtering 420 can be applied, resulting in Best Filtered Profile Matches for User 350 being provided to User 1 400.

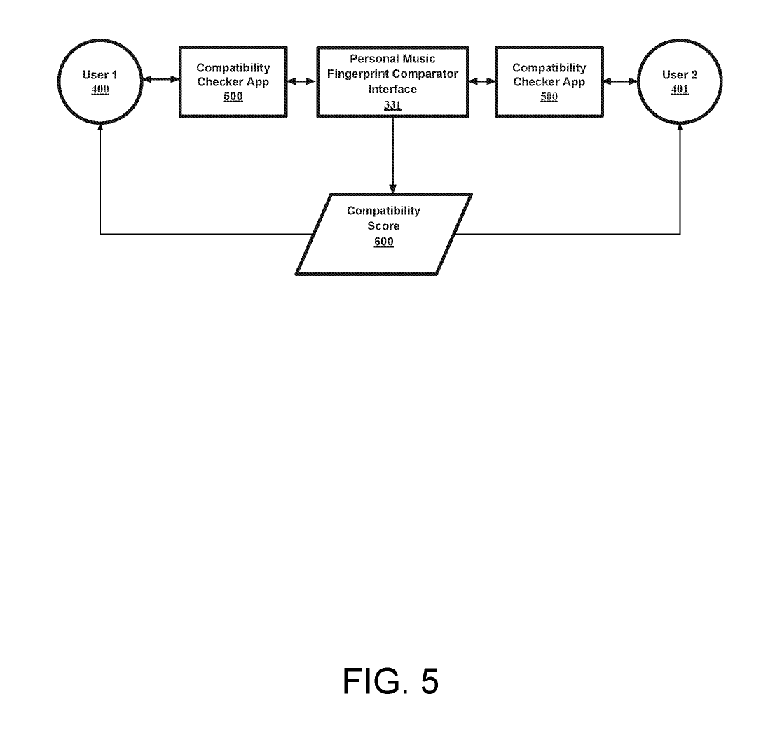

In another embodiment, real-time or on-demand compatibility comparisons between two or more individuals can be enabled on a mobile device. FIG. 5 illustrates an interaction between User 1 400 and User 2 401 through a mobile Compatibility Checker App 500, which can leverage a Personal Music Fingerprint Comparator Interface 331 to rapidly generate a Compatibility Score 600 based on the Personal Music Fingerprints 141 of the users.

In another embodiment, compatibility information and location data can be combined to trigger real-time alerts on a media player device or other mobile device. These alerts can notify users of possible matches or compatible users in their immediate area. This mobile application can then enable the ability to engage with suggested matches in close proximity by sharing photo or messaging.

### 1. Online/Web-Based Implementation

An online or web-based application can facilitate some or all of the key elements and steps, such as profile generation, profile browsing and profile matching processes, communicating and connecting with prospective matches. These online or web-based applications can:
a. Provide users with a location independent way to connect with a broader base of users using mobile or other computing devices.
b. Be realized via mobile app or web app or website.
c. Enable users to find compatible users from anywhere and connect using various web-based tools or mobile apps.
d. Enable multiple business models including but not limited to a subscription service with multiple tiers and ad-supported applications and/or websites.

### 2. Mobile Application for Localized Connections

An application on a mobile device can facilitate some or all of the key steps, such as profile generation, profile browsing and profile matching processes, communicating and connecting with prospective matches. These mobile applications can:
a. Leverage mobile devices and technology to allow for on-the-fly matching and connections.
b. Utilize Wi-Fi, Bluetooth, mobile networks, NFC to enable location-based alerts, a variety of actions (e.g. flirting, chatting, messaging, detail and photo sharing) as well as facilitating face-to-face meetings.
c. Provide users ability to opt in and set a variety of privacy parameters to control anonymity/protect identity, what information is shared, how it is shared and what modes of communication are used.
d. Enable users to “broadcast” or otherwise make available their music fingerprint at certain times and in certain situations (seek mode?). This makes it available for review and possible matching by other users' devices. This can be accomplished in a number of ways including Bluetooth, Wi-Fi, or mobile network.
e. Enable users to set additional parameters for matching—such as sex, age range, ethnicity, religious preference, etc. thereby creating as narrow or as broad/open a filter as they wish.
c. Utilize location information, along with user preferences, to determine features and functionality of the mobile application. GPS coordinates can be utilized to determine both a general area/market for broader matching activity as well as Bluetooth and WiFi technologies to enable a hyper local matching capability for smaller areas (restaurant, park, club, etc.). Features and actions available can depend on the level of granularity available for location information and user preferences. For example, location information can be used to filter profile match suggestions for relevance. Users can set location preferences to tailor such filtering.
d. Enable users to set “action preferences” to define what happens when a potential match occurs. Users can set preferences for what incoming and outgoing actions are acceptable. These actions, based on the preferences of the users involved, can include:
   No action
   Display a user profile with or without options for immediate action/contact
   Provide for offline contact through web based service
   Alert (visual, audible, vibration) user that there is a match and allow for various actions to be taken (“notify me of potential matches nearby”) to include:
      Anonymous introduction/communication via instant message or similar
      Provide an audible alert/ringtone on the users' devices to initiate contact and/or allow for visual evaluation prior to contact (could be same tone, simultaneous, based on music both share, etc.)
      Send or exchange (depending on user preferences) a user picture for evaluation and to facilitate initial contact should the user/users decide to do so.
      Directly dial the potentially matching user's device (where applicable) if users have selected to allow this form of contact and have agreed to provide their contact information.
      Individual actions can be automated based on particular scenarios/schemes or be presented as options to the user and executed on command/confirmation.

For example, a user is in a public place and opted in to receive alerts when possible matches are in the vicinity. Their device can notify them (vibrate for example) that matches are available and give options on how to proceed. The user could opt to reveal various details about themselves to prompt response from suggested nearby matches. Depending on settings of the possible matches, the user could directly message or otherwise contact those possible matches. Options could include getting more info (e.g. revealing full music library, last song listened to, etc.) before connecting, sending a note, arranging to meet, etc.

### Quick Match Compatibility Checker Application

An application on a mobile device can facilitate an on-the-fly comparison between two or more individuals based on varying levels of music data, based on what is readily available in a timely way for comparison, ranging from full Personal Music Profile to personal music fingerprint using one or more technologies such as Bluetooth, Wifi or NFC.
Models can be used to quickly assess compatibility of 2 or more users—where an existing Personal Music Profile 140 might or might not exist.
Local device data can be utilized if necessary for expediency or due to lack of more existing preference data.
The application can provide a visual and or audio communication of match strength.

### Embedded Service as Part of Another System or Solution

An embodiment whereby the system can be part of a related service or another application, website, business model, etc. where Personal Music Profile 140 data can be accessed and utilized via API or other means.
a. Whereby the solution can be a plugin, add-on, related or embedded service to other social networking and dating websites such as Facebook, eHarmony, Match, etc.
b. Whereby the solution can be a plugin, add-on, related or embedded service of an existing music seller, streamer or other provider such as iTunes, Google Play Music, Amazon Music, Pandora, Spotify, etc.

### Listening Audience Modeling

Aggregate Personal Music Profile 140 data can be used to provide guidance on optimal environmental music (e.g. streamed music in a physical space such as a retail location) based on preferences of current shoppers or visitors to the location, whereby visitors can be detected using one or more technologies such as WiFi, GPS, Bluetooth or NFC, and their profiles information can be retrieved and used to indicate programming that could appeal to said visitors or based on a model generated from historical data about preferences of visitors to a location or similar location at various times of day and/or days of the week.

For example, a clothing store could utilize a database of Personal Music Profiles 140 to match music based on the makeup of the current population of store visitors at a given time (as measured and characterized by mobile device recognition or other means) or using a predictive model based on who visits the store historically (on Fridays between 3 pm and 5 pm the average visitor makeup most closely matches a given profile, so play this type of music).

Transaction or other performance measuring data can also be incorporated into the database for the purpose of modeling and establishing correlations between certain music, visitor makeup and performance to establish optimal music programming.

I claim:

1. A system for predicting compatibility between a plurality of individuals based on music preferences of the individuals and comprising the steps of:
a) gathering Music Preference Data,
b) curating and analyzing the Music Preference Data,
c) creating a Personal Music Profile and Personal Music Fingerprint for each of the plurality of individuals, and
d) identifying potential compatibility between the plurality of individuals based on the Personal Music Profiles, Personal Music Fingerprint and other filtering and matching criteria

2. The system according to claim 1, further comprising a step of
a) integrating user provided data and additional relevant data, such as location, collected or provided from a plurality of other sources.

3. The system according to claim 1, wherein the Personal Music Profiles data is embedded or otherwise accessed by another solution or service, such as a traditional dating or matchmaking website or application or a music content provider or streaming service.

4. The system according to claim 1, wherein on the fly compatibility checking and matching is delivered via a mobile device application that enables users to actively or passively connect with potentially compatible users in their proximity.

5. The system according to claim 1, wherein the resulting compatibility determinations are utilized for people matching in the context of a dating service or application.

6. The system according to claim 1, wherein the Personal Music Profiles are used to generate suggestions of music programming for a given physical space at a given time or time period based on Personal Music Profiles of actual occupants of the space at a given period of time or based on a predictive model created generated from Personal Music Profiles and historical occupancy data.

7. A method for predicting compatibility between a plurality of individuals based on music preferences of the individuals and comprising the steps of:
a) gathering Music Preference Data,
b) curating and analyzing the Music Preference Data,
c) creating a Personal Music Profile and Personal Music Fingerprint for each of the plurality of individuals, and
d) identifying potential compatibility between the plurality of individuals based on the Personal Music Profiles, Personal Music Fingerprint and other filtering and matching criteria

8. The method according to claim 7, further comprising a step of
a) integrating user provided data and additional relevant data, such as location, collected or provided from a plurality of other sources.

9. The method according to claim 7, wherein the Personal Music Profiles data is embedded or otherwise accessed by another solution or service, such as a traditional dating or matchmaking website or application or a music content provider or streaming service.

10. The method according to claim 7, wherein on the fly compatibility checking and matching is delivered via a mobile device application that enables users to actively or passively connect with potentially compatible users in their proximity.

11. The method according to claim 7, wherein the resulting compatibility determinations are utilized for people matching in the context of a dating service or application.

12. The method according to claim 7, wherein the Personal Music Profiles are used to generate suggestions of music programming for a given physical space at a given time or time period based on Personal Music Profiles of actual occupants of the space at a given period of time or based on a predictive model created generated from Personal Music Profiles and historical occupancy data.
